(19) United States
(12) Patent Application Publication
(10) Pub. No.: US 2022/0256885 A1
(43) Pub. Date: Aug. 18, 2022

(54) METHOD FOR PRODUCING A FIRM GEL FOOD BODY MADE OF PLANT PROTEINS, A GEL FOOD BODY, AND USE OF AN AGGREGATOR FOR CARRYING OUT THE METHOD

(71) Applicant: Hochland SE, Heimenkirch/Allgäu (DE)

(72) Inventors: Klaus Kuhn, Bad Tölz (DE); Jasmin Dold, Freising (DE); Dirk Michael Herrmann-Bürk, Amtzell (DE)

(73) Assignee: Hochland SE, Heimenkirch/Allgäu (DE)

(21) Appl. No.: 17/292,015

(22) PCT Filed: Oct. 31, 2019
(86) PCT No.: PCT/EP2019/079868

§ 371 Date: Jan. 21, 2022

(30) Foreign Application Priority Data
Nov. 7, 2018 (EP) 18204936.1

(51) Int. Cl. A23J 3/22; A23C 20/02; A23J 3/14

(52) U.S. Cl. CPC A23J 3/225; A23J 3/14; A23C 20/025; A23C 20/02

(57) ABSTRACT

The invention relates to a method for producing a firm, in particular vegan, gel food body, preferably a gel food block, made of plant proteins, the method having the following steps:
a) providing a composition consisting of or comprising an aqueous plant protein concentrate solution
b) aggregating the composition in a pressure vessel (2) by heating the composition to a maximum temperature, then cooling the composition to a cool temperature below 100° C. and below the peak start temperature (7)
c) performing the heating and cooling at a counterpressure in the pressure vessel (2), which counterpressure acts on the composition and is above normal atmospheric pressure, in such a way that the composition is prevented from boiling.

The invention also relates to a gel food body and to the use of an aggregator (1).

### BACKGROUND OF THE INVENTION

The invention relates to a method for producing a firm, in particular vegan, gel food body, preferably a gel food block, based on plant proteins. The gel food body is characterised by a continuous phase of plant proteins aggregated with each other, i.e. three-dimensionally cross-linked, and water, i.e. by a three-dimensional plant protein matrix. Furthermore, the invention relates to an elastic and firm, preferably vegan, very preferably highly elastic smooth gel food body, preferably gel food block, in particular as a result of the method according to the invention. In addition, the invention relates to the use of an aggregator, i.e. a device, for carrying out the method according to the invention and for producing the gel food body according to the invention.

Firm vegan gel food bodies that have been available on the market so far, for example in the form of cheese substitute slices, are produced on the basis of starch gels. Hydrocolloids are also used here. The known starch gel bodies are characterised by a low protein content. If it is sought to produce alternative products with a high protein content, it known that the addition of plant proteins to a carbohydrate matrix or starch matrix is limited due to a restricted miscibility if the product is to remain an elastic gel system. Higher amounts of plant proteins lead to a destruction of the elastic starch gel, resulting in a mass that is rather mushy and thus inelastic and no longer firm. In practice, therefore, only small amounts of plant proteins (about 1 to 2% by weight) are added to the carbohydrate gel system. Firm vegan, highly elastic sausage substitutes without the addition of industrial additives such as transglutaminase or hydrocolloids are not yet available on the market. In vegetarian alternatives, the gel system is generally based on the coagulation of hen's egg white, since hen's egg white gels are comparatively insensitive to additives of any kind.

There is thus a need for a gel food body, as well as a method for its production, which is characterised by a high plant protein content and which is also designed as an elastic gel system.

Extraction methods for the recovery and concentration of plant proteins with which the functionality of the proteins is preserved are described many times in the scientific literature as well as in the patent literature.

For example, in: “Ultracentrifugal and Polyacrylamide Gel Electrophoretic Studies of Extractability and Stability of Almond Meal Proteins” by Wolf & Sathe 1998, the extraction of almond proteins under different conditions has been comprehensively described.

GB 1 318 596 A1, for example, describes extraction methods for soybeans and peanut protein.

DE 10 2014 005 466 A1 describes the extraction of rapeseed protein.

The extraction of oat protein is described, for example, in US 2016/030 9762 A1.

US 2017/023 8590 A1 describes methods for extracting mung bean protein to produce a scrambled egg substitute.

In addition, a variety of other sources exist for plant protein-specific extraction methods in which the protein functionality is preserved. In industrial practice, however, the extracts are usually dried in a spray-drying step, which leads to the denaturation of the proteins.

EP 2 984 936 A1 describes the extraction of a gellable mung bean protein concentrate.

From GB 1 300 711 A it is known to heat a protein concentrate solution under counterpressure to avoid the formation of gas bubbles. The result is a compacted, i.e. solidified mass. Preferably, hydrocolloids are used for this purpose, as well as starch, according to the publication. The publication does not disclose an aggregated mass, i.e. does not disclose a (cross-linked) gel body, but only a (compacted) mass solidified in some way. The specification recommends a continuous production process in which the protein concentrate solution is conveyed through heat exchangers and other pipelines for heating and cooling. This inevitably shears the composition.

The method described in GB 2 016 255 A also requires the application of shear force.

US 2017/105438 A describes a method for producing a meat-like product by extrusion—this inevitably results in a shearing of the product. A gel network cannot be formed in this way.

### SUMMARY OF THE INVENTION

Proceeding from the aforementioned prior art, the invention is based on the object of providing an elastic, in particular vegan, firm gel food block based on plant proteins and a method for producing same. Furthermore, the object is to propose an aggregator for carrying out the method or for producing the gel food block.

This object is achieved in respect of the method, in respect of the gel food body and in respect of the aggregator by the features all as disclosed herein.

Advantageous refinements of the invention are described herein and in the dependent claims. All combinations of at least two of the features specified in the description, the claims and/or the figures fall within the scope of the invention.

To avoid repetition, features disclosed in accordance with the method should also be considered as disclosed and claimable in accordance with the device. Likewise, features disclosed in accordance with the device are also to be considered as disclosed and claimable in accordance with the method. The disclosure additionally relates to the use of the aggregator according to the invention for carrying out the method according to the invention and for producing the gel food body according to the invention.

The invention is based on the concept of producing or specifying a, in particular vegan, firm gel food body from suitable plant proteins, such as almond proteins, cashew proteins, mung bean proteins, coconut proteins, chickpea proteins, peanut proteins, oat proteins, etc., which is characterised in that the plant proteins form the gel-like elastic network, i.e. represent the continuous phase of the gel food body. For a person skilled in the art, an elastic gel body is preferably characterised in that the condition G′ (elastic portion)>G″ (viscous portion) is satisfied for it as a result of an oscillation rheology. Other, optional additives (which can also be referred to as disturbance variables in relation to the gel network) such as fat, sugar, salt, flavour-enhancing ingredients such as herbs, colourants and/or aromatic substances, if added, serve as fillers within this continuous phase and/or as flavour carriers. The obtained gel food bodies, especially in the form of gel blocks, can serve as cheese or meat or sausage substitute foods. Further processing into blocks, slices, shreds, cubes, sticks, etc. is readily possible and is hereby disclosed as a refinement of the invention or preferred embodiment.

The starting point for the method according to the invention for the production of the gel food body is an aqueous plant protein concentrate solution, wherein the plant proteins contained therein are characterised by a high, in particular a complete functionality. This native behaviour is required in the method according to the invention in order to aggregate the proteins, i.e. to cross-link them three-dimensionally to form a plant protein gel system.

To obtain a plant protein concentrate solution suitable for the method according to the invention, i.e. for the extraction and concentration of plant proteins, recourse can be made to methods known per se, which are preferably optimally adapted to the particular protein type or raw material source.

In general it is preferred and in a further refinement of the invention it is provided to subject the plant raw materials, such as almond, peanut, coconut or chickpea, pea or bean, etc., to a pre-treatment. Oil-containing seeds, for example, can be largely freed of oil by pressing in an oil press, in particular until a residual oil content of between 10 and 12% by weight remains, whereupon the pressed seeds or the press cake can be ground. The press cake as well as the flour from it are an ideal starting material for the extraction of proteins. Seeds containing starch, such as legumes, can either be soaked or ground directly and then fed to the extraction process. All of these preparation steps are known to a person skilled in the art.

The extraction preferably proceeds according to the following basic scheme: The, in particular ground, plant raw material is mixed with water in a dilution of in particular 1:4 to 1:10. Depending on the raw material, the pH value of the water is adjusted to a value between 5.8 and 9.6, depending on the raw material. The NaCl content is generally between 0 mol/l and 2 mol/l. During the extraction, a temperature between 10° Celsius and 50° Celsius is preferably maintained, depending on the raw material, and the suspension is stirred for a minimum of between 1 and 5 hours. During this process, the proteins dissolve from the raw material and are then in a dissolved state in the solution. Preferably, this is then followed by a filtration step and in many cases a centrifugation of the filtered suspension to separate unwanted solid components. The supernatant is further processed.

In most cases, a pH-controlled precipitation of the proteins is preferably brought about, in particular at pH values between 4.5 and 5.6. Centrifugation is carried out to separate the proteins, with the resulting protein precipitate usually having a water content of between 50% by weight and 80% by weight.

The proteins are then usually re-diluted into solution, with the re-dilution being carried out with an aqueous solution of which the pH value is adjusted so that after the re-dilution the aqueous protein concentrate solution has a pH value between 4.5 and 7.5, in particular between 5.4 and 7.2. The buffer effect of the proteins must be taken into account. The solution for redilution may also contain NaCl, in particular between 0.5 and 2% by weight, depending on the protein origin. Preferably, the finished protein concentrate solution is characterised by a protein concentration between 12 and 35% by weight, in particular between 16 and 30% by weight, very preferably between 18 and 22% by weight.

It is important that the proteins are not dried after precipitation in order to maintain a high, preferably full functionality. For preservation, the protein concentrates can, for example, be frozen or, depending on the type of protein, also pasteurised.

In further refinement of the invention, the preparation of the plant protein concentrate solution is a part or upstream method step of the method according to the invention.

As mentioned, the extracted plant proteins of the plant protein concentrate solution to be used must be characterised by a sufficiently high, in particular full functionality. A plant protein concentrate solution suitable for carrying out the method according to the invention is characterised in that it has an endothermic peak in a DSC curve resulting from a dynamic differential calorimetry measurement and describing the relationship between the specific converted heat energy and the temperature, which peak is characterised by a peak temperature range over which the peak extends, delimited by a peak start temperature and a peak end temperature. In other words, the above-mentioned test method (differential calorimetry measurement), which will be explained in detail below, can be used to check whether the plant protein concentrate solution is suitable or within the scope of the invention, and whether its proteins have a high or sufficient functionality. This is the case if a peak mentioned above and described further below can be determined, it being particularly preferred if the denaturation enthalpy (corresponding to the peak area) is at least 10 J/g protein. To carry out the differential calorimetry measurement, 50 to 100 mg of the plant protein concentrate with a known protein content are weighed into a steel vessel with a volume of 100 μl and closed pressure-tight. Another steel vessel is filled with water and serves as a reference for the measurement. The preferred measuring system is the Mettler Toledo Type DSC 1 Star. The differential calorimetry measurement consists of performing a temperature scan with a heating rate of 2 K/min. The scan range starts at 25° Celsius and preferably ends at 130° Celsius. Denaturation of the proteins in a specific temperature range becomes visible in the DSC curve obtained as an endothermic peak. Such a peak is characterised by a peak start temperature, a peak maximum temperature, i.e. a temperature at the peak maximum, in particular between 90° Celsius and 125° Celsius, and a peak end temperature. The temperature range, i.e. the peak temperature range, which is passed through here between the peak start temperature and the peak end temperature, is preferably between 25° Celsius and 40° Celsius, in particular between 30° Celsius and 35° Celsius. The peak area of the endothermic peak in the DSC curve is a measure of the extent of denaturation. Different proteins have different denaturation enthalpies. In the case of particularly suitable plant protein concentrate solutions, these are preferably above 10 J/g protein, very particularly preferably between 12 J/g and 30 J/g protein. For a particular, i.e. specific type of protein, the denaturation enthalpy is a measure of how much of the protein present is still native, i.e. has a functionality, and how much has already been denatured. The highest value possible is sought.

Within the scope of the invention, it has been found that although the formation of a peak in a DSC curve in a differential calorimetry measurement of a plant protein concentrate solution to be used is a first necessary prerequisite for the suitability and form or quality of the plant protein concentrate solution for carrying out a method according to the invention, the denaturing of the plant proteins is not synonymous with their aggregation behaviour, i.e. gel-forming behaviour. In other words, the plant proteins of the plant protein concentrate solution to be used must not only be characterised by native, i.e. still denaturable plant proteins, but additionally by a suitable gel-forming behaviour as a second quality prerequisite. For example, a plant protein concentrate solution based on lupine protein shows a clear peak in a differential calorimetry measurement carried out as described, but still does not form elastic gels. Presumably, the causes for this can be seen at the molecular level. It is assumed that a basic prerequisite for gel formation is the outward folding of the internal SH groups of the proteins, which can then react with each other to form disulphide bridges. In addition, hydrophobic interactions that are strong to a greater or lesser extent are formed between the proteins.

Whether the plant protein concentrate solution used has sufficient aggregation behaviour to carry out the method according to the invention or whether the plant protein type used is suitable for carrying out the method according to the invention (lupine, for example, is not), i.e. whether it satisfies the second quality prerequisite, can be checked by means of oscillation rheology. The advantage of this method is that the measured substance, i.e. in the present case the plant protein concentrate solution used, is not influenced in any way by the measurement, since it is not stirred, but the measuring system only oscillates through a small angle. To carry out the oscillation rheology, the plant protein concentrate solution is filled into a suitable steel vessel (beaker: C25 DIN system), more specifically between 10 and 15 ml. The steel vessel is closed pressure-tight. The rheological properties are measured by means of the cylinder (C25 DIN system) which is located in the steel vessel (beaker) with the protein concentrate solution. The cylinder in the beaker is driven by a magnetic coupling so that the system is absolutely pressure-tight. The Bohlin Gemini HR^{nano} coaxial cylinder (C25 DIN3019) is the preferred measuring system. G′ and G″ are measured, i.e. the elastic and the viscous portion of the viscoelastic concentrate. The two portions G′ and G″ change with the subsequent temperature program. The starting temperature is 25° Celsius. Then, a rapid heating with a heating rate between 3 K/min and 5 K/min takes place up to the relevant peak end temperature from the previous differential calorimetry measurement. A short holding time between 2 and 5 min at this temperature ensures that the plant protein concentrate was also completely exposed to this temperature. Thereafter, cooling is performed rapidly at a rate between 3 K/min and 5 K/min. During the aforementioned temperature program, G′ and G″ are continuously recorded. During the heating phase, an extreme increase in the G′ values (storage modulus values) is observed, especially in the region of the peak initial temperature for suitable plant protein concentrate solutions with an aggregation behaviour suitable or sufficient for carrying out the method according to the invention. The plant protein concentrate solution is suitable for carrying out the method according to the invention if the storage modulus still increases during the heating phase by at least a factor of 6, in particular a factor of 6-12, very particularly preferably a factor of 7 to 12, compared with the storage value at the beginning of the measurement, in particular at 25° Celsius. Lupine protein does not reach this factor. The storage modulus G′ then continues to increase during cooling until the gel is solidified. However, characteristic of aggregation behaviour suitable for the method according to the invention is the increase in G′ during the heating phase in the range between the peak start temperature and the peak end temperature—surprisingly, the modulus of elasticity increases with increasing temperature until the peak end temperature is reached.

The selection or suitability of the plant protein concentrate (plant protein concentrate solution) used is an essential part of the invention. The tests described above serve to characterise a plant protein concentrate solution for carrying out the invention or serve to define a suitable quality of the plant protein concentrate solution. Based on a suitable plant protein concentrate solution, a composition (formulation) can be prepared as the basis for the aggregation process according to the invention. The composition may, in the simplest case, consist solely of the plant protein concentrate solution or, more preferably, may contain at least one further ingredient, such as fat and/or sugar and/or salt and/or flavouring and/or colourant. The total protein content of the composition is or is adjusted to a value between 12% by weight and 28% by weight. The protein contents or proportions disclosed in the scope of the present application are preferably determined by means of nitrogen determination according to Kjeldahl (AOAC 991.20 “Cheese Method”).

Similarly to the protein concentrate solution, the composition is characterised in that it has an endothermic peak in a DSC curve resulting from a dynamic differential calorimetry measurement and describing the relationship between the specific converted heat energy and the temperature, which peak is characterised by a peak temperature range over which the peak extends, which is limited by a peak start temperature and a peak end temperature. The determination of the DSC curve of the composition with its endothermic peak as well as the associated peak temperatures, such as the peak start temperature, the peak end temperature, the peak temperature range and the peak maximum temperature, is carried out as previously described in conjunction with the protein concentrate solution, with the difference that, instead of the protein concentrate solution, 50 to 100 mg of the composition are examined or subjected to the differential calorimetry measurement. Specifically, this means that, to carry out the differential calorimetry measurement of the composition, 50 to 100 mg of the composition are weighed into a steel vessel with a volume of 100 μl and closed in a pressure-tight manner. Another steel vessel is filled with water and serves as a reference for the measurement. The preferred measuring system is the Mettler Toledo Type DSC 1 Star. The differential calorimetry measurement consists of performing a temperature scan with a heating rate of 2 K/min. The scan range starts at 25° Celsius and preferably ends at 130° Celsius. Denaturation of the proteins in a specific temperature range becomes visible in the DSC curve obtained as an endothermic peak. Such a peak is characterised by a peak start temperature and a peak maximum temperature, i.e. a temperature at the peak maximum.

In the simplest case, the composition may correspond to the protein concentrate solution, or it may preferably differ from it by additives such as fat, etc. Preferably, the composition is vegan—in this case, the fat or fats are vegetable fats. However, it is also conceivable to use animal fat in addition or as an alternative to vegetable fat. Depending on the type and amount of the additives, such as NaCl, these lead to a change in the composition of the aqueous phase, whereby the endothermic peak of the composition can be shifted on the temperature axis compared to the endothermic peak of the protein concentrate solution. For example, if NaCl is added in conjunction with the preparation of the composition, this results in the endothermic peak of the composition being shifted towards higher temperatures as compared to the endothermic peak of the protein concentrate solution. Preferably, the NaCl content of the composition is adjusted, either by NaCl addition or by choosing a protein concentrate solution with a correspondingly high NaCl content, such that the peak end temperature of the endothermic peak of the composition is at least 94° C., preferably at least 96° C., still more preferably at least 98° C., very particularly preferably at least 100° C. or above. It is important for the aggregation of the composition described below that the peak temperatures described in conjunction with the aggregation of the composition (formulation) are those from the DSC curve of the composition. When reference is made to peak temperatures or composition peak temperatures in the context of composition aggregation, these are thus peak temperatures from the DSC curve of the differential calorimetry measurement of the composition.

The aggregation of the composition to form an elastic, firm gel generally takes place above 100° Celsius in accordance with the invention, depending on the type of protein and, if necessary, the choice of an appropriate NaCl content. In cases where the peak end temperature of the composition, also according to the invention, is just below 100° Celsius (this may be the case, for example, with mung bean protein), in particular above 94° Celsius, even more preferably above 98° Celsius, a temperature increase of the composition to at least 100° Celsius nevertheless takes place in accordance with the invention, at least partially during the aggregation—this is due to the fact that, in order to achieve a suitable maximum temperature of the composition for the aggregation, the heating means used must be heated to a higher temperature than this maximum temperature, in order to achieve a sufficient or optimum aggregation in a justifiable process time, as a result of which temperatures of above 100° Celsius are reached at least partially in the composition. Since, above 100° Celsius, the water vapour pressure is higher than the ambient air pressure and in particular higher than the atmospheric normal pressure (1013 mbar), the aggregation is carried out in accordance with the invention in a closable, pressure-tight vessel (pressure vessel) which is designed for a corresponding overpressure, in particular for an absolute pressure between 1.3 and 5 bar, in particular between 2 and 3 bar. The composition is heated via suitable heating means in the pressure vessel to the aforementioned maximum temperature (not to be confused with the lower maximum temperature at the peak maximum of the endothermic peak of the composition), which is in particular at least partially at least 100° Celsius. The maximum temperature is characterised by being above the peak start temperature of the composition and preferably above the peak maximum temperature of the differential calorimetry measurement of the composition. As will be explained later, the maximum temperature is preferably in the range of the peak end temperature of the composition. After reaching the maximum temperature, in particular after observing an optional hot holding time which will be explained later, the composition is cooled down, specifically to a cooling temperature which is below 100° Celsius and below the peak start temperature of the composition. The pressure vessel used in accordance with the invention is required to prevent boiling and thus undesirable bubble formation during the aggregation process by means of a counterpressure acting on the composition. As will be explained later, the counterpressure is at least the saturated vapour pressure of the composition at a relevant process temperature, preferably plus a safety margin.

With regard to the provision of the counterpressure, there are different possibilities.

For the heating phase, it is conceivable that the counterpressure is formed solely by the heating process in the pressure vessel without any further measures. At least for the cooling process, however, an active counterpressurisation of the composition must take place at least temporarily until the temperature has fallen completely below the 100° Celsius limit, for example by applying an appropriate compressed gas, in particular compressed air, to the pressure vessel. In the simplest case, the build-up of a suitable counterpressure sufficient for the entire aggregation process takes place already before and/or during heating. Of course, the invention is not limited to providing the counterpressure by compressed gas, in particular compressed air—other alternatives, such as a mechanical and/or hydraulic pressurisation of the pressure vessel and/or the composition, in particular by deformation of the composition by volume reduction of the pressure vessel, for example by retracting a piston, etc., are conceivable—it is essential that, as mentioned, gas bubble formation by boiling is avoided, in particular and especially during the cooling phase, since here there is in particular a partial risk of boiling in the contact area of the composition with surrounding materials. In any case, a corresponding counterpressure above atmospheric pressure should be present and maintained at least for as long as the composition has a temperature of 100° Celsius or higher, even if only partially.

Overall, the method according to the invention results in a gel food body that is preferably free from air inclusions, is firm, and preferably vegan, with a continuous phase based on aggregated, i.e. three-dimensionally cross-linked plant proteins, which is characterised by a high protein content and good gel properties. The gel food body is particularly suitable for use as a cheese or sausage substitute and can be provided in the form of blocks, slices, shreds, sticks or cubes, etc.

In addition to the fact that the method according to the invention allows the plant protein content to be adjusted to almost any desired level in the product, i.e. in the gel food body, a significant advantage of the method according to the invention and of the gel food body according to the invention is that the actual gel system is formed by the plant proteins and no additional gelling agents such as starch or hydrocolloids are required. It is therefore preferable to dispense with the addition of starch and/or hydrocolloids and/or other gelling agents.

It has been shown that it is advantageous for the quality, i.e. the firmness and elasticity of the plant protein gel, to pass through the peak temperature range, i.e. the temperature range of the DSC peak of the composition to a large extent, in particular for the most part, very particularly preferably completely, further preferably as quickly as possible, and the composition temperature should be brought back below the DSC peak starting temperature of the composition as quickly as possible after heating by selecting a preferred large cooling rate which will be explained later. It is preferred here that the plant protein concentrate also reaches the intended maximum temperature completely. Increasing the temperature too slowly, incompletely reaching the maximum temperature, as well as excessively long holding times in the range of the maximum temperature can lead to a deterioration of the gel quality. It is particularly preferred to reach the peak end temperature of the denaturation peak of the composition in order to thus produce gels with optimal properties.

Conventionally, masses are heated in containers either by heating the container wall and stirring the masses or by direct introduction of steam at an elevated temperature (direct steam). In a further development of the invention, however, no shear force should be introduced during the aggregation of the composition, and in particular no stirring should be carried out, since this can lead to irreversible destruction of the gels. Therefore, introduction of direct steam should be avoided. However, this then has the consequence that heating takes place solely through the heat conduction of the composition, which is very time-consuming. In particular, care should be taken to avoid over-processing the outer areas of the composition by choosing temperatures that are too high.

In order to avoid damage to or destruction of the gel system, it is provided in accordance with the invention that, in particular at least, during cooling no shear force is introduced into the composition, for example by stirring.

It is very particularly preferable if not only cooling takes place without the application of shear force, but also if shear force is not applied for at least a period of time during heating, in particular in the final phase of heating.

In a refinement of the invention, it is therefore advantageously provided that the heating, in particular at least from reaching the peak maximum temperature, preferably at least from reaching a heating temperature which corresponds to the peak start temperature plus 20%, further preferably at least from reaching a heating temperature which corresponds to the peak start temperature plus 10%, still further preferably at least from reaching the peak start temperature, is carried out without introduction of shear force, in particular without stirring. It is very particularly preferred to carry out the entire heating process without the introduction of shear force.

It is also preferred to dispense with heating by direct steam injection—overall, it is advantageous to keep movement or mixing of the composition during aggregation (heating and cooling phase) to a minimum and preferably to avoid it completely.

With regard to the preferred form or quality of a plant protein concentrate solution suitable for carrying out the method according to the invention or to be obtained and/or provided, this has already been comprehensively explained. It is of particular advantage if the plant protein concentrate solution, in addition to the forming of an endothermic peak in the DSC curve of a differential calorimetry measurement and in addition to an increase (at least sixfold) of the storage modulus G′ in an oscillation rheology measurement already described in detail, is characterised in that it can be aggregated (under the application of counterpressure according to the invention) to form a gel body of which the storage modulus G′ in a plate-plate rheometer leads to a measured value of at least 30,000 Pa, preferably at least 50,000 Pa, more preferably between 50,000 Pa and 150,000 Pa, even more preferably between 50,000 Pa and 100,000 Pa. In other words, a plant protein concentrate solution particularly suitable for carrying out the method according to the invention should, in a refinement of the invention, as a third quality prerequisite, lead by aggregation to a gel body which, in a rheological measurement as mentioned before, leads to a storage modulus value G′ as indicated before.

For aggregation, i.e. for the forming of a corresponding gel block with a high storage modulus, the aggregation of the plant protein concentrate solution is carried out as indicated in claim 1 in conjunction with the aggregation of the composition, i.e. in a pressure vessel by heating to a maximum temperature, in particular at least partially of at least 100° Celsius and above the peak start temperature of the plant protein concentrate solution, in particular to the peak end temperature, whereupon the plant protein concentrate solution or the gel which has already formed is cooled to a temperature below 100° Celsius and below the peak start temperature of the plant protein concentrate solution, the heating and the cooling, at least in the region of temperatures above 100° Celsius, taking place at a counterpressure in the pressure vessel which acts on the plant protein concentrate solution and is above atmospheric normal pressure, in such a way that boiling of the plant protein concentrate solution is avoided. To determine the storage modulus G′ of the gel body thus obtained, a circular slice with a diameter of 20 mm and a thickness or height of 2.5 mm is obtained from it, in particular by cutting. The slice is tempered to 16° Celsius and then placed directly on the measuring unit and the gap distance is adjusted to 2.5 mm. A Bohlin rheometer Gemini HR Nano with a plate-plate measuring system (PP20) is preferably used. For measurement, the slice is placed directly under the upper plate in the rheometer and lowered until a normal force of 1N is established. Then, the sample is oscillated at a constant deformation mode of 1% at a frequency of 1 Hz. The measurement points after 100, 200 and 300s are exported and an average value is calculated. Plant protein concentrate solutions made from unsuitable plant proteins, such as lupine in particular, do not achieve the desired high storage modulus values and do not lead to the desired highly elastic gel systems, but rather to mushy particle gels.

It is particularly preferred if the plant protein concentrate solution to be used has a certain percentage of plant proteins between 12 and 35% by weight and/or a pH value from a value range between 4.0 and 7.5, in particular between 5.4 and 7.2. It is particularly preferred if the NaCl content of the plant protein concentrate solution is between 0 and 1.0 mol/l. It is particularly advantageous if the plant protein concentrate solution is such that the denaturation enthalpy of the proteins of the plant protein concentrate solution which can be determined by means of the dynamic differential calorimetry measurement described above is at least 10 J/g, in particular between 10 J/g and 30 J/g, more preferably between 15 J/g and 25 J/g. It has been found to be particularly advantageous if the storage modulus G′ of the plant protein concentrate solution in the aforementioned oscillation rheology measurement, described inter alia in claim 1, after the peak temperature range of the plant protein concentrate solution has been passed through from the peak start temperature in the direction of the peak end temperature of the plant protein concentrate solution, i.e. even before the start of the cooling process, is at least 900 Pa and very particularly preferably has a value from a range between 900 Pa and 1500 Pa, in particular between 900 and 1200 Pa.

With regard to the choice of the magnitude of the counterpressure, it is preferred if it corresponds at least to the saturated vapour pressure of the composition at the relevant temperature of the composition during the aggregation process. Preferably, it is the saturated steam pressure plus a safety margin of at least 0.1 bar, preferably at least 0.25 bar or higher.

As already mentioned, the counterpressure acting on the composition can be generated and/or applied in different ways. The simplest way is to apply an appropriately high and certainly sufficient counterpressure already before the heating phase and/or during the heating phase in the pressure vessel. In principle, as mentioned, it is conceivable that a (natural) counterpressure builds up automatically exclusively through the heating of the composition in the closed pressure vessel. At the latest during cooling, active application of a sufficiently high counterpressure must be provided to ensure that the existing counterpressure is sufficiently high to prevent boiling. This is due to the fact that the gel body generally cools more slowly during cooling than a medium and/or material surrounding it, such as a heater and/or a container wall, as a result of which partial boiling and thus the formation of gas bubbles can occur in the contact area between the gel body and the surrounding medium and/or material if the counterpressure is insufficient, which is avoided in accordance with the invention by maintaining a sufficient counterpressure.

As already mentioned, in order to obtain optimal gel system properties, it is advantageous to pass through the entire peak temperature range of the endothermic peak of the composition, i.e. the temperature range between the peak start and peak end temperatures of the composition, at least approximately completely, very particularly preferably completely, during the heating phase. As a minimum requirement, the maximum temperature to which the composition is heated for aggregation should at least correspond to the peak maximum temperature at the peak maximum of the endothermic peak of the composition or, further preferably, should be selected from a temperature range between the peak maximum temperature of the composition and the peak end temperature of the composition and/or the peak maximum temperature of the composition and peak end temperature of the composition plus a temperature supplement. The temperature supplement is preferably 20% of the peak maximum temperature, preferably only 19% of the peak maximum temperature, further preferably only 18% of the peak maximum temperature, even further preferably only 17% of the peak maximum temperature, very particularly preferably only 16% of the peak maximum temperature, even further preferably only 15% of the peak maximum temperature, even further preferably only 14% of the peak maximum temperature, even further preferably only 13% of the peak maximum temperature, even further preferably only 12% of the peak maximum temperature, even further preferably only 11% of the peak maximum temperature, even further preferably only 10% of the peak maximum temperature. In other words, it is preferred if the maximum temperature reached during heating is between the peak maximum temperature and an upper temperature limit, which is the peak maximum temperature plus the previously disclosed temperature supplement. If the upper temperature limit is exceeded, the result is a crumbly texture with a correspondingly unpleasant feel in the mouth, which is not perceived as a cohesive gel body. In principle, a slight exceeding of the peak end temperature of the composition is not critical. Preferably, the maximum temperature is at most equal to the peak end temperature of the composition plus 20% and/or the maximum temperature is equal to the peak end temperature of the composition ±10° Celsius, preferably ±5° Celsius, in particular ±3° Celsius, more preferably ±1° Celsius.

It is preferred if the average heating rate, at least from reaching the peak start temperature of the composition, and/or the average cooling rate, at least until reaching the peak start temperature of the composition, is at least 4 K/min, more preferably at least 8 K/min, and/or is selected from a value range between 4 K/min and 15 K/min, more preferably between 8 K/min and 15 K/min. It is particularly preferred to keep the heating rate and/or the cooling rate constant, at least in the temperature range of the peak temperature range of the composition. If the minimum and/or maximum heating rate and/or the minimum and/or maximum cooling rate is undershot or exceeded respectively, the result is an excessively crumbly texture with a correspondingly unpleasant feel in the mouth, which is not perceived as a cohesive gel body.

Depending on the plant protein type, it may be expedient to provide a heat-holding phase after the heating phase before the start of the cooling phase, in particular between 0.5 min and 10 min, preferably between 0.2 min and 10 min, more preferably between 0.1 min and 10 min, wherein the heat-holding temperature is selected from a temperature range between the peak maximum temperature of the composition and the maximum temperature and very particularly preferably corresponds to the maximum temperature. In a further refinement of the invention, the upper limit of the duration of the heat-holding phase of 10 min indicated above may be reduced, in particular to 5 min or 1 min. If the upper limit of the heat-holding time is exceeded, the result is a crumbly texture with a correspondingly unpleasant feel in the mouth, which is not perceived as a cohesive gel body.

With regard to the selection of the plant proteins as the basis for extraction and concentration to obtain the plant protein concentrate to be used, there are different possibilities. In principle, it is possible to form the plant protein concentration purely from one type or as a mixture of at least two different plant types. Preferably, the plant proteins (one type or as a mixture) are obtained from the following plant raw materials, although the selection is not limited to this: almond, mung bean, coconut, chickpea, peanut, cashew, oat, pea, bean, rice, wheat gluten, lentils, amaranth, beans, white beans, kidney beans, fava beans, soy beans, cereals.

In further refinement of the invention, it is advantageously provided that the fat content of the composition is selected from a range of values between 0% by weight and 30% by weight, in particular between 1% by weight and 30% by weight, further preferably between 10% by weight and 20% by weight. The fat content discussed in the context of the present disclosure can be determined according to the commonly used Soxhlet method AOAC 933.05 Fat in Cheese. In addition or alternatively to a fat, preferably solid at room temperature of 22° Celsius, sugar may be added to the composition as an ingredient. Additionally or alternatively, it is preferred to adjust the NaCl content of the composition to a value from a value range between 1.1 and 1.6% by weight. In particular, by setting an appropriate salt content, it can be ensured, which is preferred, that the peak end temperature of the composition at aggregation is above 94° Celsius, preferably above 98° Celsius, very particularly preferably at least 100° Celsius or above, and very particularly preferably in a temperature range between 101° Celsius and 140° Celsius. Particularly in the case of the optional addition of larger amounts of sugar, the peak end temperature of the composition may also be above this, since the addition of sugar (as in the case of NaCl addition) shifts the denaturation peak of the composition (compared to the denaturation peak of the protein concentrate solution) towards higher temperatures. The addition of sugar, especially sucrose, is possible up to a total sugar content of the composition of 60% by weight.

In addition or as an alternative to fat and/or sugar and/or salt, the composition may comprise at least one functional ingredient, in particular from the group of substances: colouring substance, flavouring, in particular cheese flavouring, preservative, flavour-enhancing ingredient, in particular herbs. It is preferable in particular to dispense with preservatives.

Preferably, the ingredients of the composition, in particular if the composition contains fat, are emulsified, in particular by an appropriate introduction of shear force, it being particularly preferred if, during and/or in particular after the emulsification phase, gas bubbles are extracted from the composition and/or foam is formed during the emulsification method is removed, more specifically by an evacuation method or step in which the composition is subjected to negative pressure.

In the following, eight example formulations for advantageous compositions based on an almond protein concentrate solution (examples 1 to 4), and also based on a mung bean protein concentrate solution (examples 5 to 8) are shown in the form of Tables 1 to 4. The various protein concentrate solutions are referred to as protein concentrate in the tables. The values given are percentages by weight.

TABLE 1
Almond formulations without the addition of functional ingredients

| | Example 1 | Example 2 |
|---|---|---|
| Almond protein concentrate | 85 | — |
| (18% protein, 1.9% NaCl) | | |
| Almond protein concentrate | — | 80 |
| (22% protein, 1.6% NaCl) | | |
| Coconut oil | 15 | 20 |
| Total | 100 | 100 |
| Fat (absolute) | 15 | 20 |
| Fat in dry matter | 43 | 48 |
| Protein (absolute) | 15.3 | 17.6 |
| Protein/water | 18.9 | 23.3 |
| Salt (absolute) | 1.6 | 1.3 |

TABLE 2
Almond formulations with functional ingredients

| | Example 3 | Example 4 |
|---|---|---|
| Almond protein concentrate | 83.8 | — |
| (18% protein, 1.9% NaCl) | | |
| Almond protein concentrate | — | 78.8 |
| (22% protein, 1.6% NaCl) | | |
| Coconut oil | 15 | 20 |
| Colouring ingredients | 0.2 | 0.2 |
| Flavour-enhancing ingredients | 1.0 | 1.0 |
| Preservatives | — | — |
| Total | 100 | 100 |
| Fat (absolute) | 15 | 20 |
| Fat in dry matter | 44 | 48 |
| Protein (absolute) | 15.1 | 17.3 |
| Protein/water | 18.7 | 22.9 |
| Salt (absolute) | 1.6 | 1.3 |

TABLE 3
Mung bean formulations without the
addition of functional ingredients

| | Example 5 | Example 6 |
|---|---|---|
| Mung bean protein concentrate | 85 | — |
| (18% protein, 1.7% NaCl) | | |
| Mung bean protein concentrate | — | 80 |
| (22% protein, 1.4% NaCl | | |
| Coconut oil | 15 | 20 |
| Total | 100 | 100 |
| Fat (absolute) | 15 | 20 |
| Fat in dry matter | 46 | 50 |
| Protein (absolute) | 15.3 | 17.6 |
| Protein/water | 18.5 | 22.6 |
| Salt (absolute) | 1.4 | 1.1 |

TABLE 4
Mung bean formulations with functional ingredients

| | Example 7 | Example 8 |
|---|---|---|
| Mung bean protein concentrate | 83.8 | — |
| (18% protein, 1.7% NaCl) | | |
| Mung bean protein concentrate | — | 78.8 |
| (18% protein, 1.4% NaCl | | |
| Coconut oil | 15 | 20 |
| Colouring ingredients | 0.2 | 0.2 |
| Flavour-enhancing ingredients | 1.0 | 1.0 |
| Preservatives | — | — |
| Total | 100 | 100 |
| Fat (absolute) | 15 | 20 |
| Fat in dry matter | 46 | 51 |
| Protein (absolute) | 15.1 | 17..3 |
| Protein/water | 18.2 | 22.2 |
| Salt (absolute) | 1.4 | 1.1 |

In order to obtain a continuous protein network, it is essential to limit the amount of non-protein components, since these represent disturbance variables in relation to the continuous phase. Here, the total protein content and the protein content in relation to the water phase are important.

TABLE 5
Limit values for fat and protein to
obtain a continuous protein phase

| | MIN | MAX |
|---|---|---|
| Absolute fat % | 0 | 30 |
| Fat in dry matter % | 0 | 65 |
| Absolute protein % | 12 | 35* |
| Protein/water % | 16 | 38* |

Table 5 shows the above-mentioned different limiting parameters which, in a refinement of the invention, should be observed by the composition to obtain a protein network having desired properties, such as elastic properties and firmness properties. The addition of fat can be minimised to zero, since it does not play a supporting role in aggregation. The fat content should be limited upwardly, since otherwise a disturbance of the protein cross-linking is possible. As a lower limit for the forming of a highly elastic protein network, a minimum total protein content of 12% by weight and/or a protein/water ratio of 16% should be maintained. The protein/water ratio or the protein/water content depends on the fat content. If the fat content is increased in the formulation, i.e. in the composition, the protein/water ratio should also be increased, as can be seen, for example, from Example 9 shown below. The specified maximum values for the protein content or the protein/water ratio should be evaluated as a process limit, since higher protein contents lead to highly viscous masses, which cause comparatively difficult handling.

Table 6 below shows two defined limit formulations using the example of a composition based on an almond protein concentrate solution:

TABLE 6
Limit formulations using the example of almond

| | Example 9 | Example 10 |
|---|---|---|
| Almond protein concentrate | 70 | — |
| (18% protein, 1.9% NaCl) | | |
| Almond protein concentrate | — | 80 |
| (35% protein, 1.7% NaCl | | |
| Coconut oil | 30 | 20 |
| Colouring ingredients | — | — |
| Flavour-enhancing ingredients | — | — |
| Preservatives | — | — |
| Total | 100 | 100 |
| Fat (absolute) | 30 | 20 |
| Fat in dry matter | 65.0 | 38 |
| Protein (absolute) | 12.6 | 28 |
| Protein/water | 18.9 | 37.9 |
| Salt (absolute) | 1.4 | 1.4 |

Example 9 shows a formulation or composition with which a continuous protein network can still be reliably formed despite an increased fat content and lowered protein content. If the protein content is further reduced, although the protein/water ratio is kept the same, this could lead to the proteins no longer linking or cross-linking/aggregating with each other, resulting in a mushy, non-elastic consistency. If the protein/water ratio is lowered and the total protein content remains the same, this can also be detrimental to the forming of a continuous protein scaffold.

Example 10 shows a maximum formulation or composition with twice the protein content in the water phase. It is conceivable to set the protein content even higher in order to still obtain a stable protein network. However, due to the associated increase in viscosity, the composition becomes much more difficult to handle.

Table 7 below shows limit formulations using the example of a composition based on a mung bean protein concentrate solution.

TABLE 7
Limit formulations using the example of mung bean

| | Example 11 | Example 12 |
|---|---|---|
| Mung Bean Protein Concentrate | 70 | — |
| (18% protein, 1.9% NaCl) | | |
| Mung Bean Protein Concentrate | — | 80 |
| (35% protein, 1.7% NaCl) | | |
| Coconut oil | 30 | 20 |
| Colouring ingredients | — | — |
| Flavour-enhancing ingredients | — | — |
| Preservatives | — | — |
| Total | 100 | 100 |
| Fat (absolute) | 30 | 20 |
| Fat in dry matter | 67 | 40 |
| Protein (absolute) | 12.6 | 28 |
| Protein/water | 18.5 | 36.2 |
| Salt (absolute) | 1.2 | 1.1 |

Example 11 shows a composition with which a continuous protein network can still be formed despite an increased fat content and lowered protein content. If the protein content is further reduced, although the protein/water ratio is kept the same, this could lead to the proteins no longer cross-linking (sufficiently), thus increasing the risk of a mushy, non-elastic consistency developing. If the protein/water ratio is lowered and the total protein content remains the same, the risk of not being able to build up a continuous protein scaffold also increases.

Example 12 shows a maximum formulation or composition with twice the protein content in the water phase. Here, too, it is conceivable to set the protein content higher and still obtain a stable protein network. However, due to the increasing viscosity, handling would become more difficult.

The invention also leads to a preferably highly elastic smooth, preferably vegan, gel food body, in particular in the form of a gel food block, obtained in particular by carrying out a method according to the invention, the continuous aqueous phase of which consists of plant proteins aggregated with one another, i.e. cross-linked three-dimensionally, the gel food body being characterised by a content, in percentage by weight, of plant proteins aggregated with one another from a value range between 12 and 28% by weight and a fat content between 0 and 30% by weight. The gel food body can be provided in the form of a block, in the form of slices, sticks, cubes, shreds, etc., in particular by comminuting a gel food block obtained as the result of the method.

It is particularly preferred if the gel food body has a firmness from a value range between 15N and 40N, in particular between 17N and 35N. Preferably, the breaking strength of a gel food body according to the invention is between 20N and 70N, more preferably between 25N and 45N. It is particularly preferred if the elasticity of a gel food body according to the invention is between 85% and 100%, very particularly preferably between 90% and 95%. Preferably, the bending capacity of a food body according to the invention is between 80% and 100%, preferably between 85% and 98%. The bending strength of a gel food body formed according to the concept of the invention is preferably between 10 mN and 1000 mN, preferably between 15 mN and 400 mN.

The parameters discussed or disclosed in the present disclosure, namely firmness, elasticity and breaking strength, are determined by means of a so-called texture analyser. Specifically, the Texture Analyser TA-XTplus, Stable Micro Systems was used. A modified texture profile analysis is used to measure the firmness, breaking strength and elasticity, with the samples being standardised as follows: Circular cylinder shape with a diameter of 47 mm and a height of 25 mm. The samples shall be tempered to 16° Celsius.

In order to determine the firmness and elasticity, a double compression of the sample is to be carried out; settings at the texture analyser, which can be taken from the following Table 8, shall be made:

TABLE 8
Settings

| | |
|---|---|
| | Test Mode: Compression |
| | PreTest Speed: 5 mm/s |
| | Test Speed: 1 mm/s |
| | PostTest Speed (night test speed): 5 mm/s |
| | Target Mode: Distance |
| | Distance: 5 mm |
| | Trigger Type: Auto (Force) |
| | Trigger Force: 1 g |
| | Break Mode: Off |
| | Stop Plot At (End Position): Start Position |
| | Tare Mode: Auto |
| | Advanced Options: Off |
| Measuring cell | 5 kg |
| (power cell) | |
| Measuring pin | ½″ Cyl. Delrin P/0.5 |
| (measuring ram) | |
| Temperature | 16° C. |
| (temperature) | |

Compression of the sample by 5 mm corresponds to a deformation of 20% of the total height. After the first measurement, the measuring plunger is moved back to its starting point and the sample is left to rest for 15 s, before another compression takes place. The firmness corresponds to the maximum force from the first measuring cycle. The elasticity is calculated from the ratio of the positive peak areas of both measurements in a graph in which the applied force is plotted over time.

For the breaking strength, the force required for non-reversible deformation of the sample is determined. A penetration depth of 15 mm should be selected here. The peak maximum of a measurement curve in a graph in which the applied force is plotted over time corresponds to the breaking strength.

The bending capacity and bending strength parameters discussed in the context of the present disclosure are determined using the texture analyser: Texture Analyser TA-XTplus, Stable Micro Systems.

TABLE 9
Settings

| | |
|---|---|
| Test settings | Test Mode: Compression |
| | PreTest Speed: 1 mm/s |
| | Test Speed: 1 mm/s |
| | PostTest Speed: 5 mm/s |
| | Target Mode: Distance |
| | Distance: 25 mm |
| | Trigger Type: Auto (Force) |
| | Trigger Force: 1 g |
| | Break Mode: Off |
| | Stop Plot At (End Position): Start Position |
| | Tare Mode: Auto |
| | Advanced Options: Off |
| Measuring cell | 5 kg |
| (power cell) | |
| Measuring pin | SMS P/75 |
| (measuring ram) | |
| Temperature | 16° C. |
| (temperature) | |

For the bending test to be carried out by means of the texture analyser, the samples are standardised as follows:

Rectangular slice 35×30 mm with a thickness (material thickness) of 2 mm. The samples are tempered to a temperature of 16° Celsius.

The bending capacity is the percentage of the distance by which the sample (slice) can be compressed in the texture measuring apparatus without breaking. The distance between the base plate and the measuring ram is set to 32 mm as the starting position before the sample is clamped between them in height.

If the slice is still intact after complete compression, this corresponds to a bending capacity of 100%. In this case, the maximum positive force is reached at the end point of the distance. If the sample breaks before full compression has been reached, this can be recognised by an abrupt drop in the force absorbed. The bending strength corresponds here to the maximum measured force in mN. In this case, the bending capacity is calculated from the ratio of the distance at break and the maximum distance.

The invention also leads to an aggregator and its use for carrying out a method according to the invention, wherein the aggregator according to the invention comprises a pressure vessel for receiving the composition to be aggregated. Furthermore, the aggregator comprises heating and cooling means for heating and cooling the composition, wherein the heating and cooling means (device or devices for heating and cooling) are preferably designed in such a way that the process parameters specified in the context of the disclosure of the method, such as the heating and cooling rate, can be satisfied or are satisfied with them. It is essential that the pressure vessel is associated with counterpressure setting means for setting a counterpressure which acts on the composition at least temporarily, i.e. at least at temperatures of the composition of at least partially at least 100° Celsius, as explained in the context of the above disclosure. The counterpressure setting means can comprise, for example, a compressed gas connection, in particular a compressed air connection, by means of which the vessel interior can be brought to the counterpressure disclosed in the context of the disclosure of the method. However, as explained in detail within the scope of the disclosure of the method, the counterpressure means are not limited to such a compressed gas design—also realisable within the scope of the invention are alternative counterpressure setting means which generate the counterpressure acting on the composition, for example, mechanically or hydraulically and/or by changing the volume of the pressure vessel, etc.

The aggregator is to be considered disclosed as essential to the invention in spite of the absence of a patent claim, in particular with a possible wording of a claim as follows:
an aggregator (1) for carrying out a method according to one of claims 1 to 13, comprising a pressure vessel (2) for receiving the composition to be aggregated, heating and cooling means (6) for heating and cooling the composition in the pressure vessel (2), and preferably counterpressure setting means (4) for setting a counterpressure, acting on the composition during aggregation, above atmospheric pressure.

### BRIEF DESCRIPTION OF THE DRAWINGS

Further advantages, features and details of the invention will become apparent from the following description of preferred embodiment examples and from the figures.

These show in:

FIG. 1 a preferred production process for producing a protein concentrate solution using the example of almond,

FIG. 2 the course of aggregation of a composition based on an almond protein concentrate solution,

FIG. 3 a typical DSC graph of a plant protein concentrate solution,

FIG. 4 a production process for producing a composition (formulation) based on an almond protein concentrate,

FIG. 5 a production process for producing a composition (formulation) based on a mung bean protein concentrate solution,

FIG. 6 a graph showing the firmness, breaking strength, elasticity and water content of different natural cheeses.

FIG. 7 a graph in which the parameters according to FIG. 6 are shown for gel food bodies based on different plant protein concentrates, in which lupine denotes a product not included in the invention,

FIG. 8 a graph showing the bending capacity and bending strength of different natural cheeses,

FIG. 9 a graph showing the parameters according to FIG. 8 for gel food bodies produced on the basis of compositions based on different plant protein concentrate solutions,

and

FIG. 10 in a schematic representation, a possible embodiment of an aggregator.

The information and parameter values disclosed in the description of the figures are not intended to limit the invention. However, they are to be regarded as essential to the invention and thus disclosed such that they could be claimed.

### DETAILED DESCRIPTION

In the figures, like elements are denoted by like reference signs.

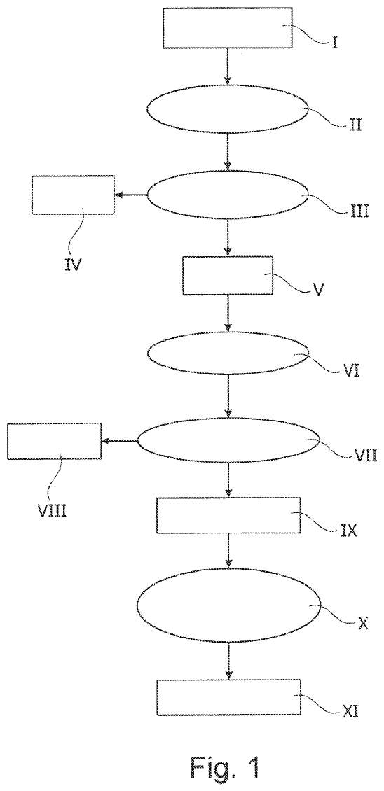

FIG. 1 shows a possible process for producing a protein concentrate solution using the example of almond.

At I, almond flour is provided, for example comprising 45 to 55% by weight protein and 11 to 16% by weight fat, the protein content preferably being at least 50% by weight and the fat content preferably being at most 13% by weight.

At II, the plant protein is extracted in water at a dilution of 1:4, the pH value preferably being adjusted to between 5.8 and 6.5. A pH value of 6.0 is particularly preferred. The extraction is carried out in particular at a temperature between 15 and 25° Celsius, very particularly preferably at 20° Celsius, the extraction time being at least one hour, preferably during stirring, in particular at a speed between 300 and 600 rpm, preferably 400 rpm.

This is followed by centrifugation at III and a residue is obtained at IV. The supernatant is denoted by V. The centrifugation at III. is preferably carried out for at least one hour at a preferred temperature between 15 and 25° Celsius, very particularly preferably 20° Celsius. The centrifugation is preferably carried out at between 14,000 and 27,000 g, very particularly preferably at 27,000 g.

An acid precipitation of the protein of the supernatant is then carried out at VI, in particular at a pH value between 4.8 and 5.2, very particularly preferably of 5.2. The precipitation is preferably carried out over a period of time of at least 30 minutes, very particularly preferably of one hour, in particular at a temperature from a range of values between 15 and 25° Celsius, in particular of 20° Celsius.

The precipitated protein is then centrifuged at VII, in particular at 14,000 to 27,000 g, in particular at 27,000 g, very particularly preferably for at least 20 minutes, even more preferably for 45 minutes, in particular at a temperature between 4 and 8° Celsius, very particularly preferably at 8° Celsius.

A supernatant is obtained at VIII. The residue at IX. is acidic protein concentrate (protein precipitate) with a protein weight content between 45 and 50%.

At X the pH value as well as the protein and NaCl concentration are adjusted. Preferably, the pH is adjusted to a value in a range between 5.2 and 6.5, very particularly preferably to 5.4. Preferably, the protein content is adjusted to 16 to 30% by weight, particularly preferably to 18 to 22%, and the NaCl content is adjusted to 0 to 3.3% by weight, very particularly preferably to 1.6 to 1.9% by weight. The process result at XI is a protein concentrate solution suitable for carrying out a method according to the invention.

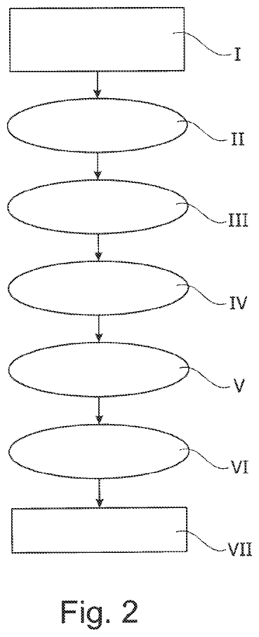

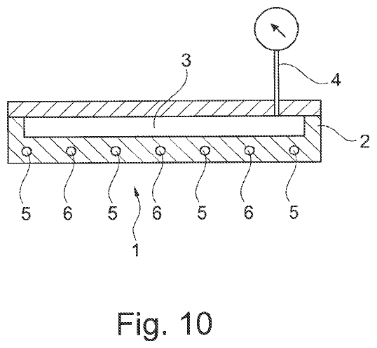

FIG. 2 shows the course of aggregating a composition to obtain an aggregated product, i.e. a gel food body. An aggregator 1 is used for this purpose, as shown by way of example in FIG. 10. A pressure vessel 2 designed for overpressure can be seen. The pressure vessel 2 delimits an internal volume 3 (vessel volume) for accommodating a composition designed according to the concept of the invention. The pressure vessel 2 can be closed in a pressure-tight manner and can be subjected to a counterpressure above atmospheric pressure with the aid of counterpressure setting means 4.

Heating means 5 and cooling means 6 are also assigned to the pressure vessel 2. The heating means 5 are designed in the present case, for example, as electrical heating cartridges in the vessel wall, while the cooling means 6 comprise cooling channels through which a cooling medium can be conveyed.

At I, a composition is provided in the form of an emulsion based on an almond protein concentrate solution. The composition comprises, for example, between 13 and 24% by weight protein, between 0 and 2.8% by weight NaCl, between 0 and 1.8% by weight flavouring, in the present case cheese flavouring, and between 10 and 30% by weight fat. At II, such a composition is placed in an aggregator and at III a counterpressure of, for example, at least 1.3 bar is set. At IV, a heating phase takes place, in particular with a heating rate of 6.5 and 8 K/min. to a maximum temperature between 108° Celsius and 120° Celsius. At V, the heating phase is followed by an optional heat-holding time at a maximum temperature of between 0 and 10 min, whereupon at VI. a cooling phase takes place, in particular at a cooling rate of between 7 and 8.5 K/min. At VII, a gel food body according to the invention is obtained.

In the following Table 10, preferred aggregation conditions are shown using the example of an almond protein concentrate solution:

TABLE 10
Aggregation conditions using the example
of almond protein concentrate

| | MIN | MAX | OPTIMUM |
|---|---|---|---|
| Heating phase | 6.5 | 8.0 | 8.0 |
| Holding time (min) | 0 | 10 | 0 |
| Cooling phase | 7.0 | 8.5 | 8.5 |
| Temperature (° C.) | 108 | 120 | 113 |

The following table 11 shows preferred minimum and maximum as well as optimum maximum temperatures to which different compositions based on different plant protein concentrate solutions shown in the table are heated in the aggregator during the heating phase, wherein T-min denotes a preferred minimum maximum temperature to be set, T-max denotes a preferred maximum maximum temperature to be selected and T-opt denotes an optimum maximum temperature to be set for aggregation.

TABLE 11
preferred minimum, maximum and optimum maximum temperatures
for the aggregation of a composition based on different
plant protein concentrate solutions.

| | Tₘᵢₙ(° C.) | Tₘₐₓ(° C.) | T_{opt.}(° C.) |
|---|---|---|---|
| Almond protein | 108 | 120 | 113 |
| Mung protein | 95 | 108 | 100 |
| Coconut protein | 108 | 120 | 113 |
| Chickpea protein | 108 | 120 | 113 |
| Oat protein | 118 | 125 | 120 |
| Peanut protein | 110 | 120 | 115 |

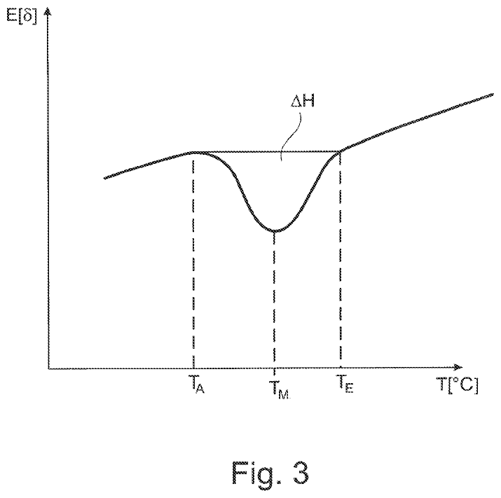

FIG. 3 shows a typical DSC curve from a dynamic differential calorimetry measurement of a suitable plant protein concentrate solution. It can be seen that the specific heat energy converted is plotted over temperature in the graph. The curve shows an endothermic peak, where the peak area represents the denaturation enthalpy ΔH of the contained proteins.

The peak extends over a peak temperature range from a peak start temperature T_{A} to a peak end temperature T_{E}. The peak has a maximum at a peak maximum temperature T_{M}. The maximum temperature to which a composition is preferably heated for aggregation is preferably in the range of the peak end temperature T_{E}, in any case above the peak maximum temperature T_{M}.

The separate presentation of a DSC curve from a dynamic differential calorimetry measurement of a composition (formulation) has been omitted. The above explanations of the endothermic peak and the associated temperatures apply analogously. By adding ingredients, especially salt, the endothermic peak of the DSC curve of the composition may be shifted on the temperature axis compared to the endothermic peak of the DSC curve of the corresponding protein concentrate solution, in case of NaCl addition further to the right. Likewise, the peak may be shifted further to the left, i.e. towards lower temperatures, by corresponding dilution of the aqueous phase protein concentrate solution, in particular of its NaCl content in conjunction with the production of the composition, for example by addition of water. The peak temperatures from the DSC curve of the composition are decisive for the selection of the maximum temperature for aggregating the composition.

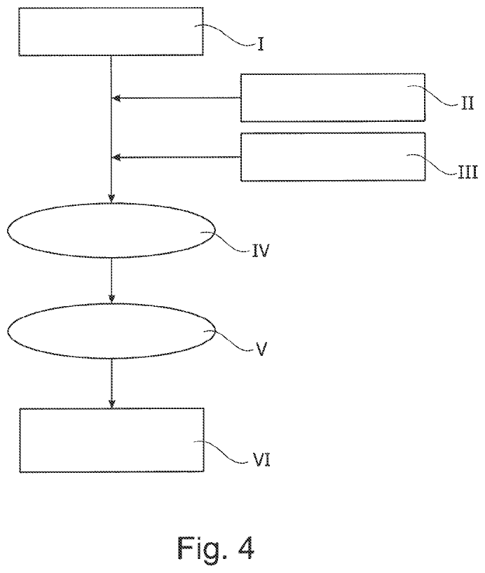

FIG. 4 shows a possible production of a composition using the example of almond. At I, a protein concentrate solution based on almond protein is provided. This is preferably characterised by a protein content of between 16 and 30% by weight, in particular between 18 and 22% by weight, and by an NaCl content of between 0 and 3.3% by weight, preferably between 1.6 and 1.9% by weight. The protein concentrate solution is further preferably characterised by a pH value between 5.2 and 6.5, in particular of 5.4.

At II, melted fat, in particular coconut fat, is added, preferably at a temperature between 45 and 60° Celsius. At III, flavouring is added, for example between 0 and 2% by weight.

At IV, an emulsification step takes place, in particular for 1 to 3 min at preferably 8,000 to 20,000 rpm. Very particularly preferably, emulsification is carried out for 2 min at a rotation speed of between 15,000 and 20,000 rpm.

An evacuation step is then carried out at five to remove gas bubbles and/or to destroy the foam formed during the emulsification process, in particular for 2 to 5 min, even more preferably for 3 min. The pressure for the evacuation is preferably reduced to 100 to 300 mbar, very particularly preferably to 150 mbar—the evacuation is preferably carried out at a temperature between 20 and 25° Celsius.

As a result, a composition in the form of a protein-based almond emulsion is then obtained at VI, which is preferably characterised by a protein weight content of between 13 and 24% by weight, preferably between 15 and 17.5% by weight, an NaCl content of between 0 and 2.8% by weight, in particular between 1.3 and 1.6% by weight, a flavouring content of between 0 and 1.8% by weight and a fat content of between 10 and 30% by weight, in particular between 15 and 20% by weight.

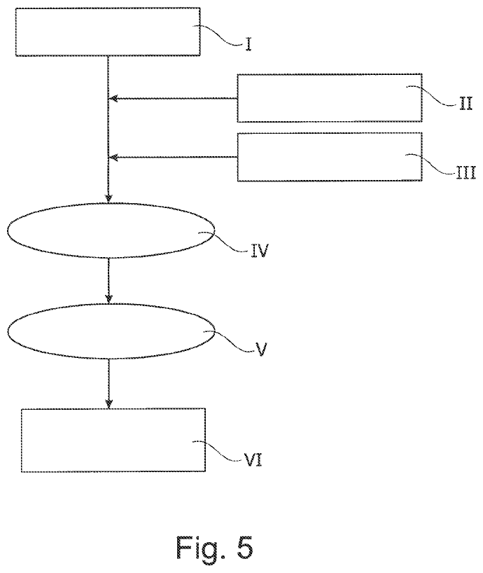

FIG. 5 shows an exemplary production process for a composition based on a mung bean protein concentrate solution. This is prepared at I. and is preferably characterised by a protein weight content of between 16 and 30% by weight, in particular between 18 and 22% by weight, an NaCl content of between 0 and 3.3% by weight, in particular between 1.4 and 1.7% by weight, and a pH value of between 5.2 and 6.5, preferably of 5.8.

Steps II to V are then identical to those as explained in conjunction with FIG. 4. As a method result, at VI a composition in the form of a protein-based mung bean emulsion is obtained, wherein the preferred protein, NaCl, flavouring and fat contents correspond to those from the embodiment example according to FIG. 4.

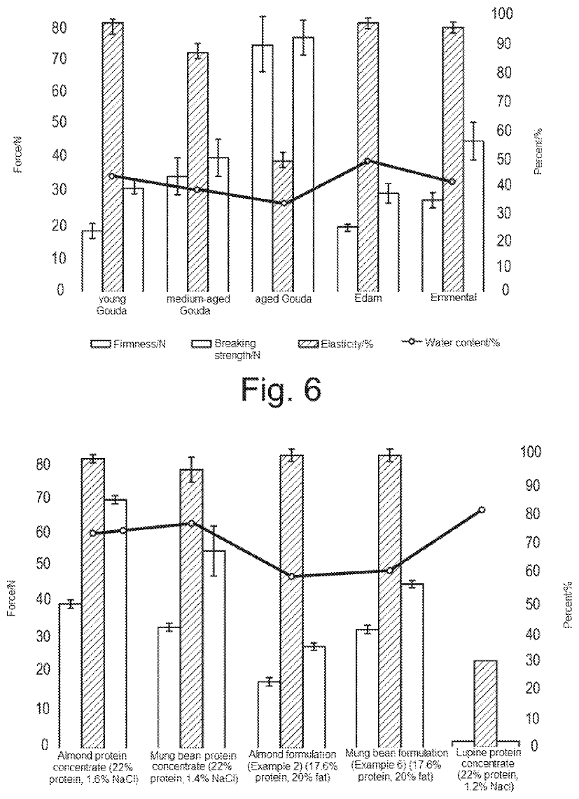

FIG. 6 shows that the characterisation of the selected standard products (different types of cheese) shows that the four parameters shown—firmness, breaking strength, elasticity and water content—correlate with each other.

The firmness and breaking strength increase as the water content decreases, while the elasticity decreases at the same time. While young Gouda still has an elasticity of 95%, this drops to 85 and 46% for medium-aged and aged Gouda respectively. Edam and Emmental are both in a range similar to young Gouda, namely 95 and 93%. The firmness and breaking strength are highest in aged Gouda at 70 and 72N respectively, with the water content being lowest here at 31% by weight. The medium-aged Gouda has a structure that is almost half a firm (firmness: 32.7N; breaking strength: 37.9N), with the water content being only 4.5% by weight higher. The water content of Edam and Gouda is the highest at 45 and 41%, the firmnesses are consequently the lowest at 17.6 and 17.2N, and 27.3 and 29.1 N breaking strength respectively. Emmental comes in just behind the two, with a firmness of 25N and a breaking strength of just under 42N.

When looking at the plant gels or gel food bodies according to FIG. 7, it can be seen that the correlation of the water content only applies to a limited extent.

The water content of the aggregated concentrates is around 70 and 73% by weight for almond and mung bean respectively. In the formulations (see Example 2 and Example 6), this drops to 55 and 57% by weight (almond and mung bean) due to the addition of fat. The firmnesses and breaking strengths as well as the elasticities can be compared with the conventional types. The almond gel without the addition of fat has the highest firmness (38N) and breaking strength (65N), and shows a very high elasticity (95%), which is comparable to a young Gouda. When fat is added, the firmness of the almond formulation decreases significantly to a value of 17.2N, which is also comparable to a young Gouda or Edam. The breaking strength of the almond sample is 26N, which is in the region of that of Edam. The elasticity remains almost identical, around 95%. The mung bean sample without the addition of fat has a firmness equivalent to medium-aged Gouda (32N), with a slightly higher breaking strength of 52N. Elasticity, at 91%, is just below that of an Emmental sample. The mung bean formulation benefits from the addition of fat in terms of elasticity and achieves a value of almost 96% here. The firmness and breaking strength are 31 and 42N respectively. As in the oscillation measurements, the aggregated lupine protein concentrate shows significantly worse values in all areas. The firmness and the breaking strength are equal, since the sample breaks already at a low penetration depth. These values are around 0.9N. The elasticity of the sample is also extremely low at 27.5%. It can be seen from this that the aggregate made from a lupine protein concentrate-based composition is not part of the invention, but merely serves as a comparative approach.

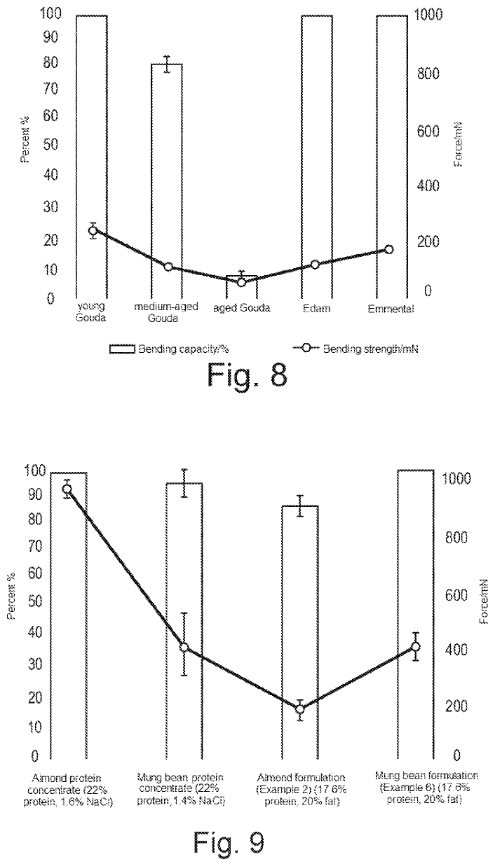

As can be seen from FIG. 8, easily recognisable differences can be found in the determination of the bending capacity and bending strength for the cheese standards.

The slices of young Gouda, Edam and Emmental are still intact after a complete compression cycle and therefore have a bending capacity of 100%. A force of about 125 mN is needed for a complete compression of Edam, whereas Emmental requires on average about 50 mN more force. Young Gouda has the highest bending strength. Here, the value is around 260 mN. The older and less elastic cheeses, middle-aged and old Gouda, cannot withstand the bending test. After about 83% of the distance, the medium old Gouda breaks. The bending strength (corresponding to the force at break) is correspondingly lower, namely 115 mN. The aged Gouda has an extremely poor bending capacity. It breaks already after 6.5% of the distance, after a required force of just under 52 mN.

Compared to the conventional cheese products, there are many parallels in the plant products or gel food bodies as shown in FIG. 9.

The samples without additives (22% by weight protein, almond: 1.6% by weight NaCl, mung. 1.4% by weight NaCl) both show a very high bending capacity. The almond sample shows an analogous behaviour here to the young Gouda, Edam and Emmental, with 100% bending capacity. The bending strength is comparatively very high, at 1037 mN. The sample from mung protein concentrate shows a bending capacity of almost 96%, with a bending strength of 424 mN. When 20% by weight fat is added to the almond protein concentrate (see formulation example 2), the bending capacity drops to 87%, which is equivalent to a structure between a young and a medium-aged Gouda. The bending capacity drops significantly to 176 mN, which is in the region of that of Emmental. When fat is added to the mung protein concentrate (see formulation example 6), the bending capacity increases again, reaching almost 100%. The bending strength here, at 420 mN, is again somewhat higher than the conventional cheese types. The bending test could not be carried out on the aggregate of a composition based on lupine protein concentrate solution, as no firm end product was formed during aggregation.

### LIST OF REFERENCE SIGNS

1. Aggregator
2. Pressure vessel
3. Internal volume
4. Counterpressure setting means
5. Heating means
6. Cooling means
T_{A} Peak start temperature
T_{E} Peak end temperature
T_{M} Peak maximum temperature

1-15 (canceled)

16. A method for producing a firm, vegan, gel food body, made of plant proteins, the method having the following steps:
a) providing a composition comprising an aqueous plant protein concentrate solution with plant proteins, wherein the amount of the plant protein concentrate solution is selected such that the protein content of the composition, in percentage by weight, is between 12% by weight and 28% by weight, wherein the composition is heated and cooled in a pressure vessel,
b) performing the heating and cooling at a counterpressure in the pressure vessel (2), which counterpressure acts on the composition and is above normal atmospheric pressure, in such a way that the composition is prevented from boiling, wherein the counterpressure corresponds at least to the saturated vapour pressure of the composition at a relevant process temperature, and wherein the cooling is performed without introduction of shear force,
wherein
c) the content, in percentage by weight, of the plant proteins in the plant protein concentrate solution is selected from a value range between 12 and 35% by weight, and wherein the plant protein concentrate solution is such that it has an endothermic peak in a DSC curve resulting from a dynamic differential calorimetry measurement and describing the relationship between the specific converted heat energy and the temperature, which peak is characterised by a peak temperature range over which the peak extends, which is delimited by a peak start temperature and a peak end temperature, and wherein the storage modulus G′ of the plant protein concentrate solution increases by at least a factor of 6, when passing through the peak temperature range from the peak start temperature in the direction of the peak end temperature in an oscillation rheology measurement, and wherein the denaturation enthalpy of the proteins of the plant protein concentrate solution which can be determined by means of the dynamic differential calorimetry measurement is at least 10 J/g, and
d) wherein the composition is characterised in that it has an endothermic peak in a DSC curve resulting from a dynamic differential calorimetry measurement and describing the relationship between the specific converted heat energy and the temperature, which peak is characterised by a peak temperature range over which the peak extends, which is delimited by a peak start temperature and a peak end temperature, and
e) wherein the composition is aggregated in the pressure vessel (2) by heating the composition to a maximum temperature at least partially of at least 100° C. and above the peak start temperature of the endothermic peak of the composition, in a pressure vessel (2) and then cooling the composition to a cool temperature lying below 100° C. and below the peak start temperature of the composition, and wherein the addition of starch and/or hydrocolloids is omitted, and
f) wherein the maximum temperature to which the composition is heated is selected from a temperature range between the peak maximum temperature of the composition and the peak end temperature of the composition plus 20%, and in that the average heating rate, at least from reaching the peak start temperature of the composition, is selected from a value range between 4 K/min and 15 K/min.

17. The method according to claim 16, wherein the plant protein concentrate solution has a pH value from a value range between 4.5 and 7.5, and/or wherein the NaCl concentration of the plant protein concentrate solution is selected from a value range between 0 and 1.0 mol/l.

18. The method according to claim 16, wherein the plant protein concentrate solution is such that the denaturation enthalpy of the proteins of the plant protein concentrate solution, which can be determined by means of the dynamic differential calorimetry measurement, is between 10 J/g and 30 J/g.

19. The method according to claim 16, wherein the counterpressure above normal atmospheric pressure corresponds at least to the saturated vapour pressure of the composition at the relevant temperature in addition to a safety margin of at least 0.1 bar.

20. The method according to claim 19, wherein the safety margin is at at least 0.5 bar.

21. The method according to claim 16, wherein the pressure vessel (2) is actively subjected to the counterpressure before and/or during and/or after heating, and/or wherein the counterpressure is maintained during cooling at least until the aggregated composition has cooled completely below 100° C.

22. The method according to claim 16, wherein the heating is carried out without introduction of shear force.

23. The method according to claim 16, wherein the composition is kept hot prior to cooling for a period of time between 0.5 to 10 min at a heat-holding temperature lying between the peak maximum temperature of the composition and the maximum temperature.

24. The method according to claim 16, wherein the average cooling rate, at least until reaching the peak start temperature of the composition, is at least 4 K/min, and/or is selected from a value range between 4 K/min and 15 K/min.

25. The method according to claim 16, wherein the plant proteins of the plant protein concentrate are extracted from one or more plant raw materials selected from the group consisting of almond, mung bean, coconut, chickpea, peanut, cashew, oat, pea, bean, rice, wheat gluten, lentils, amaranth, beans, white beans, kidney beans, fava beans, soy beans, cereals and combinations thereof.

26. The method according to claim 16, wherein the fat content of the composition is adjusted to a value from a value range between 0% by weight and 30% by weight and/or wherein the sugar content of the composition is adjusted by adding sugar to a value from a value range between 0% by weight and 60% by weight, and/or wherein the NaCl content of the composition is adjusted to a value from a range between 1.1 and 1.6% by weight.

27. The method according to claim 16, wherein the composition comprises at least one functional ingredient selected from the group of ingredients consisting of: colouring substance, flavouring, preservative, flavour-enhancing ingredient and combinations thereof.

28. The method according to claim 16, wherein the ingredients of the composition are emulsified, and wherein gas bubbles are removed from the emulsion under a negative pressure atmosphere and/or foam formed in the emulsion is removed.

29. The method according to claim 16, wherein, to carry out the differential calorimetry measurement, 50 to 100 mg of the plant protein concentrate with the known protein content are weighed into a steel vessel with a volume of 100 μl and closed pressure-tight, wherein a further steel vessel is filled with water and serves as a reference for the measurement, and wherein a Mettler Toledo Tpe DSC 1 Star is used as measuring system and the differential calorimetry measurement consists of performing a temperature scan with a heating rate of 2 K/min, and wherein, to carry out the oscillation rheology, the plant protein concentrate solution is filled into a suitable steel vessel (beaker: C25 DIN system), specifically between 10 and 15 ml, and wherein the steel vessel is closed pressure-tight, and wherein the rheological properties are measured by means of the cylinder (C25 DIN system), which is located in the steel vessel (beaker) with the protein concentrate solution, and wherein the cylinder in the beaker is driven by a magnetic coupling so that the system is absolutely pressure-tight, and wherein the Bohlin Gemini HR^{nano} coaxial cylinder (C25 DIN3019) measuring system is used for the measurement and the measuring system preferably oscillates only through a small angle, and wherein G′ and G″ are measured and the two portions G′ and G″ change with the subsequent temperature program, wherein the starting temperature is 25° Celsius and then a rapid heating with a heating rate between 3 K/min and 5 K/min takes place up to the relevant peak end temperature from the previous differential calorimetry measurement, wherein a short holding time between 2 and 5 min is observed at this temperature so that the plant protein concentrate is also completely exposed to this temperature, and wherein thereafter cooling is performed rapidly at a cooling rate between 3 K/min and 5 K/min, and/or wherein, to carry out the differential calorimetry measurement of the composition, 50 to 100 mg of the composition are weighed into a steel vessel with a volume of 100 μl and closed pressure-tight, and wherein a further steel vessel is filled with water and serves as a reference during the measurement, and wherein a Mettler Toledo Type DSC 1 Star is used as measuring system, and wherein the differential calorimetry measurement consists of performing a temperature scan with a heating rate of 2 K/min.

30. A firm, vegan, elastic gel food body, which is free from starch, free from hydrocolloids and is obtained by a method according to claim 16, comprising a continuous aqueous phase of mutually aggregated plant proteins and having a content, in percentage by weight, of the mutually aggregated plant proteins from a value range between 12 and 28% by weight, wherein a fat content of the gel block is between 0 and 30% by weight, and wherein the elasticity of a gel food body according to the invention to be determined by means of a texture analyser is between 85% and 100%.

31. A gel food body according to claim 30, wherein to measure the elasticity, the sample has a circular cylinder shape with a diameter of 47 mm and a height of 25 mm and shall be tempered to 16° Celsius, wherein, in order to determine the elasticity, a double compression of the sample is to be carried out, wherein, after a first measurement, a measuring stamp is returned to its starting point and the sample is left to rest for 15 s before a further compression occurs, and wherein the elasticity is calculated from the ratio of the positive peak areas of both measurements in a graph in which the applied force is plotted over time.
